(19) United States
(12) Patent Application Publication
(10) Pub. No.: US 2026/0296582 A1
(43) Pub. Date: Oct. 1, 2026

(54) DEFLECTION COMPENSATION DEVICE AND AGV VEHICLE

(71) Applicant: Guangdong Lead Intelligent Logistics Technology Co., Ltd., Zhuhai (CN)

(72) Inventor: FENGFU GU, Zhuhai (CN)

(73) Assignee: Guangdong Lead Intelligent Logistics Technology Co., Ltd., Zhuhai (CA)

(21) Appl. No.: 19/677,325

(22) Filed: May 14, 2026

Related U.S. Application Data
(63) Continuation of application No. PCT/CN2025/103501, filed on Jun. 25, 2025.

(30) Foreign Application Priority Data
Jun. 28, 2024 (CN) 202410865238.4

(51) Int. Cl. B62D 63/04; B66F 9/075

(52) U.S. Cl. CPC B62D 63/04; B66F 9/07554

(57) ABSTRACT

The disclosed subject matter provides a deflection compensation device, including a mounting member configured to mount a material shaft; a fixing plate, wherein the mounting member is rotatably connected to the fixing plate about an axis of the Y direction; a connecting member rotatably connected to the mounting member about an axis of the Y direction; and a driving mechanism disposed on the fixing plate, wherein a driving end of the driving mechanism is connected to the connecting member, the driver configured for driving the connecting member to move along the Z direction, and the mounting member is configured for rotating about the axis of the Y direction.

### CROSS-REFERENCE TO RELATED APPLICATIONS

The present disclosure is a continuation of International Application No. PCT/CN2025/103501, which claims priority to a Chinese patent application No. 202410865238.4, filed with the China National Intellectual Property Administration on Jun. 28, 2024, entitled “Deflection Compensation Device and AGV Vehicle”, both of which are incorporated herein by reference in their entireties.

### TECHNICAL FIELD

The present disclosure relates to the technical field of AGV vehicles, and particularly relates to a deflection compensation device and an AGV vehicle.

### BACKGROUND

In the related art, after a material shaft is loaded with a material, the material shaft bends downward under the action of the gravity of the material, that is, the material shaft exhibits a large deflection; when the material on the material shaft is transferred to a docking shaft, a step appears between the material shaft and the docking shaft, which thus leads to material jamming during material transfer.

### SUMMARY

An objective of the embodiments of the present application is to provide a deflection compensation device and an AGV vehicle.

According to a first aspect of the embodiments of the present application, there is provided a deflection compensation device, comprising:
a mounting member, wherein the mounting member is configured to mount a material shaft;
a fixing plate, wherein the mounting member is rotatably connected to the fixing plate about an axis of the Y direction;
a connecting member, wherein the connecting member is rotatably connected to the mounting member about the axis of the Y direction; and
a driving mechanism, wherein the driving mechanism is provided on the fixing plate, a driving end of the driving mechanism is connected to the connecting member, the driving mechanism is capable of driving the connecting member to move along the Z direction, and the mounting member is capable of rotating about the axis of the Y direction.

Optionally, the mounting member comprises a first mounting plate, a second mounting plate and a third mounting plate, one end of the first mounting plate is connected to the second mounting plate at an angle, the other end of the first mounting plate is connected to the third mounting plate at an angle, the first mounting plate is configured to mount the material shaft, the second mounting plate is rotatably connected to the fixing plate, and the third mounting plate is rotatably connected to the connecting member.

Optionally, the connecting member comprises a first connecting plate and a second connecting plate, the first connecting plate is connected to the driving end of the driving mechanism, the first connecting plate is rotatably connected to one end of the second connecting plate about the axis of the Y direction, and the other end of the second connecting plate is rotatably connected to the third mounting plate about the axis of the Y direction.

Optionally, the third mounting plate is formed with a groove along the Z direction, and the other end of the second connecting plate is embedded in the groove and rotatably connected to the third mounting plate.

Optionally, the connecting member further comprises a first slider and a second slider, the first slider and the second slider are both provided on an end of the first connecting plate adjacent to the fixing plate, and the first slider and the second slider are spaced apart along the Y direction; and
an end of the fixing plate facing the connecting member is provided with a first guide rail and a second guide rail, the first guide rail and the second guide rail are spaced apart along the Y direction, the first slider is slidably connected to the first guide rail along the Z direction, and the second slider is slidably connected to the second guide rail along the Z direction.

Optionally, the deflection compensation device further comprises a first limiting member, the first limiting member is provided on the fixing plate, and the first slider or the second slider is capable of abutting against the first limiting member; or
the deflection compensation device further comprises a first limiting member and a second limiting member, the first limiting member and the second limiting member are spaced apart on the fixing plate along the Z direction, and the first slider and the second slider are capable of moving between the first limiting member and the second limiting member.

Optionally, the deflection compensation device further comprises a third limiting member, and the third limiting member is provided on the fixing plate; and
the first connecting plate is provided with a limiting rod, the limiting rod is capable of abutting against the third limiting member, and an axis of a connecting shaft between the first connecting plate and the second connecting plate is parallel to an axis of a connecting shaft between the second connecting plate and the third mounting plate in an X-Y plane.

Optionally, the driving mechanism comprises a motor, a screw rod and a nut seat, the motor is capable of driving the screw rod to rotate about an axis of the Z direction, the nut seat is rotatably connected to the screw rod, and the first connecting plate is connected to the nut seat.

Optionally, an end of the first connecting plate facing the fixing plate is provided with an accommodating groove, and the nut seat is embedded in the accommodating groove.

Optionally, the driving mechanism further comprises a reducer, and the reducer is connected to an output end of the motor and the screw rod.

According to a second aspect of the embodiments of the present application, there is provided an AGV vehicle, comprising:
the above deflection compensation device;
a material shaft, wherein one end of the material shaft is provided on the deflection compensation device; and
a detection mechanism, wherein the detection mechanism is provided on an end of the material shaft away from the deflection compensation device, and the detection mechanism is configured to detect a deflection of the material shaft.

Optionally, the AGV vehicle further comprises a control mechanism, the detection mechanism is communicatively connected to the control mechanism, and the driving mechanism is communicatively connected to the control mechanism.

A technical effect of the embodiments of the present application is that, when the driving mechanism drives the connecting member to move downward along the Z direction, the mounting member rotates about an axis at a connection between the mounting member and the connecting member, that is, the mounting member rotates counterclockwise about the axis of the Y direction, the material shaft is mounted on the mounting member, an end of the material shaft away from the mounting member tilts upward in the Z direction, so that an axis of the material shaft and a docking shaft are on the same horizontal line, thereby facilitating smooth transfer of the material.

Other features and advantages of the present application will become apparent from the following detailed description of exemplary embodiments of the present application with reference to the accompanying drawings.

### BRIEF DESCRIPTION OF THE DRAWINGS

The accompanying drawings, which are incorporated in and constitute a part of the specification, illustrate embodiments of the present application and, together with the description, serve to explain the principles of the present application.

FIG. 1 is a schematic structural view of a deflection compensation device and a material shaft in an embodiment of the present application;

FIG. 2 is a schematic structural view of a deflection compensation device and a material shaft in an embodiment of the present application;

FIG. 3 is a cross-sectional view taken along line A-A in FIG. 2;

FIG. 4 is a schematic structural view of a deflection compensation device and a material shaft in an embodiment of the present application;

FIG. 5 is a schematic structural view of a deflection compensation device adjusting a material shaft in an embodiment of the present application;

FIG. 6 is a schematic structural view of a deflection compensation device, a material shaft and a docking shaft in an embodiment of the present application.

### DESCRIPTION OF REFERENCE NUMERALS

deflection compensation device 100; mounting member 1; first mounting plate 11; second mounting plate 12; third mounting plate 13; groove 131; first connecting portion 132; second connecting portion 133; fixing plate 2; first guide rail 21; second guide rail 22; connecting member 3; first connecting plate 31; limiting rod 311; accommodating groove 312; second connecting plate 32; first slider 33; second slider 34; driving mechanism 4; motor 41; reducer 42; screw rod 43; nut seat 44; bearing 45; bearing seat 46; first connecting shaft 5; second connecting shaft 6; first limiting member 7; second limiting member 8; third limiting member 9; fourth limiting member 10; material shaft 200; detection mechanism 300; docking shaft 400.

### DETAILED DESCRIPTION

Various exemplary embodiments of the present application will now be described in detail with reference to the accompanying drawings. It should be noted that, unless otherwise specifically stated, the relative arrangement of components and steps, numerical expressions, and numerical values set forth in these embodiments do not limit the scope of the present application.

The following description of at least one exemplary embodiment is merely illustrative in nature and is in no way intended to limit the present application, its application, or uses.

Techniques, methods, and devices known to those of ordinary skill in the relevant art may not be discussed in detail, but where appropriate, such techniques, methods, and devices should be considered as part of the specification.

In all examples shown and discussed herein, any specific values should be construed as merely exemplary and not as limiting. Accordingly, other examples of the exemplary embodiments may have different values.

It should be noted that like reference numerals and letters refer to like items in the following figures, and thus once an item is defined in one figure, it need not be further discussed in subsequent figures.

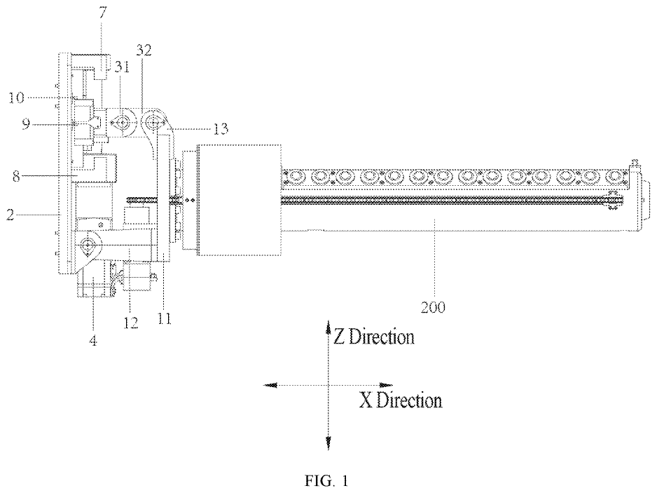

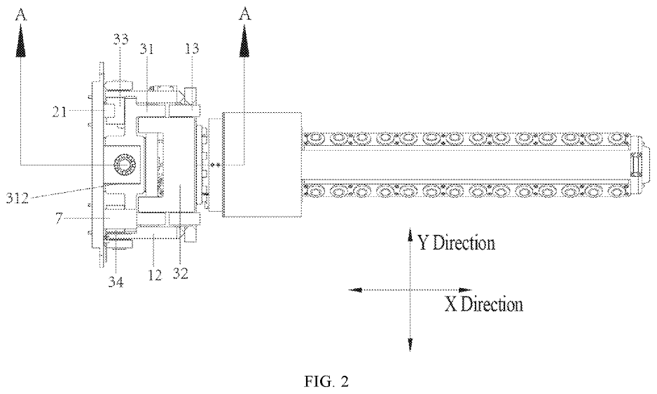

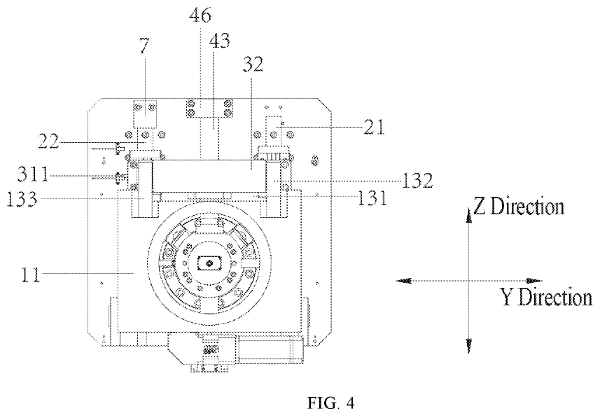

First, it is explained that for the X direction, the Y direction, and the Z direction in the embodiments of the present application, reference is made to the directions indicated in FIG. 1, FIG. 2, and FIG. 4. Herein, the X direction, the Y direction, and the Z direction intersect pairwise.

The deflection of the material shaft 200 refers to a linear displacement of an axis of the material shaft 200 in a direction perpendicular to the axis direction when the material shaft 200 is subjected to a force.

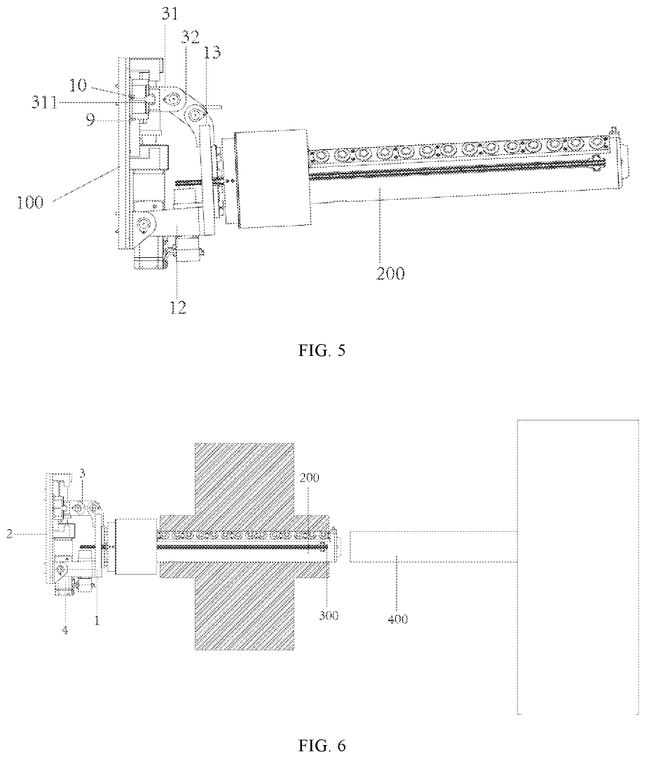

As shown in FIGS. 1-6, an embodiment of the present application provides a deflection compensation device 100, comprising a mounting member 1, a fixing plate 2, a connecting member 3 and a driving mechanism 4, wherein the mounting member 1 is configured to mount the material shaft 200; the mounting member 1 is rotatably connected to the fixing plate 2 about an axis of the Y direction; the connecting member 3 is rotatably connected to the mounting member 1 about an axis of the Y direction; the driving mechanism 4 is provided on the fixing plate 2, a driving end of the driving mechanism 4 is connected to the connecting member 3, the driving mechanism 4 is capable of driving the connecting member 3 to move along the Z direction, and the mounting member 1 is capable of rotating about the axis of the Y direction.

An embodiment of the present application provides a deflection compensation device 100. The material shaft 200 is provided on the deflection compensation device 100. The deflection compensation device 100 can adjust, in the Z direction, an axis of the material shaft 200 and an axis of a docking shaft 400 to be on the same horizontal line, thereby facilitating smooth transfer of the material located on the material shaft 200 to the docking shaft 400, and preventing occurrence of material jamming during the transfer process.

As shown in FIGS. 1, 2 and 5, the deflection compensation device 100 comprises a mounting member 1, a fixing plate 2, a connecting member 3 and a driving mechanism 4.

Herein, the mounting member 1 is rotatably connected to the fixing plate 2 about an axis of the Y direction, the mounting member 1 is rotatably connected to the connecting member 3 about an axis of the Y direction, the material shaft 200 is mounted on the mounting member 1, the mounting member 1 is rotatably connected to the fixing plate 2, and the second connecting portion 133 can improve mounting stability of the mounting member 1, thereby improving connection stability of the material shaft 200; the driving mechanism 4 is provided on the fixing plate 2, the connecting member 3 is connected to the driving end of the driving mechanism 4, and the driving mechanism 4 is capable of driving the connecting member 3 to move along the Z direction. When the material shaft 200 is loaded with a material, under the action of the gravity of the material, an end of the material shaft 200 away from the mounting member 1 bends downward in the Z direction, so the material shaft 200 exhibits a large deflection, and a step appears when docking with the docking shaft 400. Therefore, when the driving mechanism 4 drives the connecting member 3 to move downward along the Z direction, the mounting member 1 rotates about an axis at a connection between the mounting member 1 and the connecting member 3, that is, the mounting member 1 rotates counterclockwise about the axis of the Y direction, the material shaft 200 is mounted on the mounting member 1, and an end of the material shaft 200 away from the mounting member 1 tilts upward in the Z direction, so that an axis of the material shaft 200 and the docking shaft 400 are on the same horizontal line, thereby facilitating smooth transfer of the material.

In an optional embodiment, the mounting member 1 comprises a first mounting plate 11, a second mounting plate 12 and a third mounting plate 13, one end of the first mounting plate 11 is connected to the second mounting plate 12 at an angle, the other end of the first mounting plate 11 is connected to the third mounting plate 13 at an angle, the first mounting plate 11 is configured to mount the material shaft 200, the second mounting plate 12 is rotatably connected to the fixing plate 2, and the third mounting plate 13 is rotatably connected to the connecting member 3.

As shown in FIGS. 1 and 2, the mounting member 1 comprises a first mounting plate 11, a second mounting plate 12 and a third mounting plate 13. One end of the first mounting plate 11 is connected to the second mounting plate 12 at an angle, the first mounting plate 11 is spaced apart from the fixing plate 2 along the X direction, and the second mounting plate 12 is rotatably connected to the fixing plate 2 about an axis of the Y direction; the third mounting plate 13 is connected to the other end of the first mounting plate 11 at an angle, the third mounting plate 13 is rotatably connected to the connecting member 3 about an axis of the Y direction, and two ends of the first mounting plate 11 are spaced apart along the Z direction, so the third mounting plate 13 and the second mounting plate 12 are spaced apart along the Z direction.

Herein, the material shaft 200 is mounted on the first mounting plate 11, and the second mounting plate 12 is rotatably connected to the fixing plate 2. On the one hand, this can provide support for the material shaft 200 to avoid tilting of the material shaft 200 after being mounted on the first mounting plate 11; on the other hand, it facilitates rotation of the first mounting plate 11 about the axis of the Y direction, so as to improve the stability of rotation of the first mounting plate 11. The third mounting plate 13 is connected to the first mounting plate 11 at an angle, so as to facilitate rotatable connection of the third mounting plate 13 to the connecting member 3. When the connecting member 3 moves along the Z direction, the third mounting plate 13 rotates about the axis of the Y direction, thereby enabling the first mounting plate 11 to rotate about the axis of the Y direction.

In a preferred embodiment, a cross-section of the third mounting plate 13 in the Z direction is formed in an arc shape, bending toward the fixing plate 2, to avoid interference with some components, making the structure of the deflection compensation device 100 more compact.

In an optional embodiment, the connecting member 3 comprises a first connecting plate 31 and a second connecting plate 32, the first connecting plate 31 is connected to the driving end of the driving mechanism 4, the first connecting plate 31 is rotatably connected to one end of the second connecting plate 32 about an axis of the Y direction, and the other end of the second connecting plate 32 is rotatably connected to the third mounting plate 13 about an axis of the Y direction.

As shown in FIGS. 1, 2 and 5, the connecting member 3 comprises a first connecting plate 31 and a second connecting plate 32, one end of the second connecting plate 32 is rotatably connected to the first connecting plate 31 about an axis of the Y direction, the other end of the second connecting plate 32 is rotatably connected to the third mounting plate 13 about an axis of the Y direction, and the first connecting plate 31 is connected to the driving end of the driving mechanism 4; whether the driving mechanism 4 drives the first connecting plate 31 to move upward or downward along the Z direction, the first mounting plate 11 rotates counterclockwise about the axis of the Y direction, that is, in either case, an end of the material shaft 200 away from the first mounting plate 11 tilts upward in the Z direction, so that an axis of the material shaft 200 and the docking shaft 400 are on the same horizontal line. With this structure, regardless of whether the first connecting plate 31 moves upward or downward in the Z direction, it can adjust the axis of the material shaft 200 and an axis of the docking shaft 400 to be on the same horizontal line, avoiding misadjustment and also improving adjustment efficiency.

In an optional embodiment, the third mounting plate 13 is formed with a groove 131 along the Z direction, and the other end of the second connecting plate 32 is embedded in the groove 131 and rotatably connected to the third mounting plate 13.

As shown in FIGS. 1 and 4, the third mounting plate 13 is formed with a groove 131 along the Z direction. In the Y direction, a first connecting portion 132 and a second connecting portion 133 are respectively formed at two ends of the groove 131; the other end of the second connecting plate 32 is embedded in the groove 131, two ends of the second connecting plate 32 along the Y direction respectively contact the first connecting portion 132 and the second connecting portion 133, the first connecting portion 132 and the second connecting portion 133 are provided with first mounting holes, the other end of the second connecting plate 32 is provided with a second mounting hole along the Y direction, and a first connecting shaft 5 extends through the first mounting holes and the second mounting hole, so that the third mounting plate 13 is rotatably connected to the second connecting plate 32.

It is further explained that the other end of the second connecting plate 32 is embedded in the groove 131; on the one hand, the groove 131 can limit movement of the second connecting plate 32 along the Y direction, which can improve connection stability between the second connecting plate 32 and the third mounting plate 13; on the other hand, in the Z direction, it can reduce the height of the deflection compensation device 100, thereby reducing the volume of the deflection compensation device 100.

In an optional embodiment, the connecting member 3 further comprises a first slider 33 and a second slider 34, the first slider 33 and the second slider 34 are both provided on an end of the first connecting plate 31 adjacent to the fixing plate 2, and the first slider 33 and the second slider 34 are spaced apart along the Y direction; an end of the fixing plate 2 facing the connecting member 3 is provided with a first guide rail 21 and a second guide rail 22, the first guide rail 21 and the second guide rail 22 are spaced apart along the Y direction, the first slider 33 is slidably connected to the first guide rail 21 along the Z direction, and the second slider 34 is slidably connected to the second guide rail 22 along the Z direction.

As shown in FIGS. 2 and 4, the connecting member 3 further comprises a first slider 33 and a second slider 34. The first slider 33 and the second slider 34 are both provided on an end of the first connecting plate 31 facing the fixing plate 2, and the first slider 33 and the second slider 34 are spaced apart along the Y direction; the end of the fixing plate 2 facing the connecting member 3 is provided with a first guide rail 21 and a second guide rail 22, the first guide rail 21 and the second guide rail 22 are spaced apart along the Y direction, a length direction of the first guide rail 21 is the Z direction, and a length direction of the second guide rail 22 is the Z direction; the first slider 33 is slidably connected to the first guide rail 21, and the second slider 34 is slidably connected to the second guide rail 22; when the driving mechanism 4 drives the connecting member 3 to move along the Z direction, the first slider 33 moves relative to the first guide rail 21 along the Z direction, and the second slider 34 moves relative to the second guide rail 22 along the Z direction, thereby providing guide for the first connecting plate 31 and also preventing the first connecting plate 31 from tilting during movement, so as to improve the stability of adjustment of the material shaft 200.

In an optional embodiment, the deflection compensation device 100 further comprises a first limiting member 7, the first limiting member 7 is provided on the fixing plate 2, and the first slider 33 or the second slider 34 is capable of abutting against the first limiting member 7; or the deflection compensation device 100 further comprises a first limiting member 7 and a second limiting member 8, the first limiting member 7 and the second limiting member 8 are spaced apart on the fixing plate 2 along the Z direction, and the first slider 33 and the second slider 34 are capable of moving between the first limiting member 7 and the second limiting member 8.

In a specific embodiment, the deflection compensation device 100 further comprises a first limiting member 7. The first limiting member 7 is provided on the fixing plate 2; in the Z direction, the first limiting member 7 is located above the first guide rail 21 or the second guide rail 22, and if the driving mechanism 4 malfunctions, the first limiting member 7 can limit a range of upward movement of the first slider 33 or the second slider 34 in the Z direction; or, in the Z direction, the first limiting member 7 is located below the first guide rail 21 or the second guide rail 22, and if the driving mechanism 4 malfunctions, the first limiting member 7 can limit a range of downward movement of the first slider 33 or the second slider 34 in the Z direction. This prevents the first slider 33 from detaching from the first guide rail 21 or the second slider 34 from detaching from the second guide rail 22, and further prevents the material on the material shaft 200 from detaching from the material shaft 200, so as to avoid safety accidents.

In another specific embodiment, the deflection compensation device 100 further comprises a first limiting member 7 and a second limiting member 8. The first limiting member 7 and the second limiting member 8 are both provided on the fixing plate 2, and the first limiting member 7 and the second limiting member 8 are spaced apart along the Z direction. In the Z direction, the first limiting member 7 is located above the first guide rail 21 or the second guide rail 22, and the second limiting member 8 is located below the first guide rail 21 or the second guide rail 22; if the driving mechanism 4 malfunctions, the first limiting member 7 and the second limiting member 8 can limit the first connecting plate 31 between the first limiting member 7 and the second limiting member 8, preventing the first slider 33 from detaching from the first guide rail 21 or the second slider 34 from detaching from the second guide rail 22, and further preventing the material on the material shaft 200 from detaching from the material shaft 200, so as to avoid safety accidents.

Herein, the first limiting member 7 may be a limiting block or a limiting plate; the second limiting member 8 may be a limiting block or a limiting plate. The structures of the first limiting member 7 and the second limiting member 8 may be the same or different.

In an optional embodiment, the deflection compensation device 100 further comprises a third limiting member 9, and the third limiting member 9 is provided on the fixing plate 2; the first connecting plate 31 is provided with a limiting rod 311, the limiting rod 311 is capable of abutting against the third limiting member 9, and an axis of a connecting shaft between the first connecting plate 31 and the second connecting plate 32 is parallel to an axis of a connecting shaft between the second connecting plate 32 and the third mounting plate 13 in an X-Y plane.

As shown in FIGS. 1 and 4, the deflection compensation device 100 further comprises a third limiting member 9; the third limiting member 9 is provided on an end of the fixing plate 2 facing the connecting member 3; the first connecting plate 31 is provided with a limiting rod 311.

The second connecting plate 32 and the third mounting plate 13 are rotatably connected via a first connecting shaft 5, and an axis of the first connecting shaft 5 is a first axis; the first connecting plate 31 and the second connecting plate 32 are rotatably connected via a second connecting shaft 6, and an axis of the second connecting shaft 6 is a second axis. When the driving mechanism 4 drives the first connecting plate 31 to move along the Z direction and the limiting rod 311 abuts against the third limiting member 9, a plane formed by the first axis and the second axis is parallel to the X-Y plane, and the first axis is parallel to the second axis. When the first axis is parallel to the second axis, for the material shaft 200 on the first mounting plate 11 when not loaded with a material, an axis of the material shaft 200 extends along the X direction; when the material shaft 200 is empty, the driving mechanism 4 drives the first connecting plate 31 to move along the Z direction, causing the limiting rod 311 to abut against the third limiting member 9, and can quickly adjust the material shaft 200 to a horizontal state, thereby improving material loading efficiency.

In a preferred embodiment, the deflection compensation device 100 further comprises a fourth limiting member 10, the fourth limiting member 10 and the third limiting member 9 are spaced apart along the Z direction, and the limiting rod 311 is capable of moving between the third limiting member 9 and the fourth limiting member 10; when the limiting rod 311 abuts against the fourth limiting member 10, an end of the material shaft 200 away from the first mounting plate 11 tilts upward in the Z direction, so as to facilitate adjustment of the axis of the material shaft 200, so that the axis of the material shaft 200 and an axis of the docking shaft 400 are on the same horizontal line.

In a specific embodiment, the driving mechanism 4 may be a hydraulic cylinder or an electric cylinder. The connecting member 3 is connected to a piston rod of the hydraulic cylinder, or the connecting member 3 is connected to a piston rod of the electric cylinder.

In another optional embodiment, the driving mechanism 4 comprises a motor 41, a screw rod 43 and a nut seat 44, the motor 41 is capable of driving the screw rod 43 to rotate about an axis of the Z direction, the nut seat 44 is rotatably connected to the screw rod 43, and the first connecting plate 31 is connected to the nut seat 44.

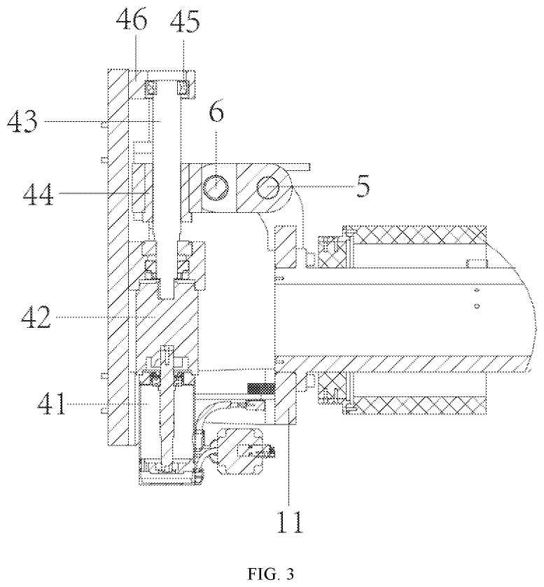

As shown in FIG. 3, the driving mechanism 4 comprises a motor 41, a screw rod 43 and a nut seat 44. Herein, the motor 41 and the screw rod 43 are mounted on the fixing plate 2, the nut seat 44 is rotatably connected to the screw rod 43, and the motor 41 is capable of driving the screw rod 43 to rotate, thereby enabling the nut seat 44 to move along the Z direction. The first connecting plate 31 is connected to the nut seat 44, and when the nut seat 44 moves along the Z direction, the first connecting plate 31 also moves along the Z direction. This structure is simple and has high stability.

In a preferred embodiment, the driving mechanism 4 further comprises a bearing seat 46 and a bearing 45. The bearing seat 46 is provided on the fixing plate 2, the bearing seat 46 is provided with a bearing hole, the bearing 45 is provided in the bearing hole, an end of the screw rod 43 away from the motor 41 is rotatably connected to the bearing 45, and the bearing seat 46 can provide support for the screw rod 43.

In an optional embodiment, an end of the first connecting plate 31 facing the fixing plate 2 is provided with an accommodating groove 312, and the nut seat 44 is embedded in the accommodating groove 312.

As shown in FIG. 2, an end of the first connecting plate 31 facing the fixing plate 2 is provided with an accommodating groove 312, and the nut seat 44 is embedded in the accommodating groove 312, thereby connecting the first connecting plate 31 to the nut seat 44, which can improve the connection strength between the first connecting plate 31 and the nut seat 44, and further improve the connection stability between the first connecting plate 31 and the nut seat 44.

In a specific embodiment, the end of the first connecting plate 31 facing the fixing plate 2 is formed with the accommodating groove 312; in another specific embodiment, the end of the first connecting plate 31 facing the fixing plate 2 is provided with a U-shaped block, the accommodating groove 312 is located in the U-shaped block, an opening of the U-shaped block faces the fixing plate 2, and the opening is communication with the accommodating groove 312, so as to facilitate embedding of the nut seat 44 in the accommodating groove 312.

In an optional embodiment, the driving mechanism 4 further comprises a reducer 42, and the reducer 42 is connected to an output end of the motor 41 and the screw rod 43.

As shown in FIG. 3, the driving mechanism 4 further comprises a reducer 42, an input end of the reducer 42 is connected to the output end of the motor 41, and an output end of the reducer 42 is connected to the screw rod 43. Thus, the motor 41 can drive the screw rod 43 to rotate, and through the reducer 42, the rotational speed of the screw rod 43 can be reduced and the torque of the screw rod 43 can be increased.

According to a second aspect of the embodiments of the present application, there is provided an AGV vehicle, comprising a deflection compensation device 100, a material shaft 200 and a detection mechanism 300; one end of the material shaft 200 is provided on the deflection compensation device 100; the detection mechanism 300 is provided on an end of the material shaft 200 away from the deflection compensation device 100, and the detection mechanism 300 is configured to detect a deflection of the material shaft 200.

AGV is an abbreviation for Automated Guided Vehicle, which refers to an unmanned automated vehicle that is equipped with automatic guidance devices such as magnetic strips, tracks or lasers, travels along a planned path, is powered by a battery, and is equipped with safety protection and various auxiliary mechanisms (e.g., transfer and assembly mechanisms).

As shown in FIG. 6, an AGV vehicle comprises a deflection compensation device 100, a material shaft 200 and a detection mechanism 300.

Herein, the material shaft 200 is provided on the deflection compensation device 100. Specifically, one end of the material shaft 200 is mounted on the first mounting plate 11, an axis of the material shaft 200 is parallel to an axis of the X direction, and the detection mechanism 300 is provided on an end of the material shaft 200 away from the deflection compensation device 100. The detection mechanism 300 can detect the deflection of the material shaft 200, so that the deflection compensation device 100 can adjust the material shaft 200.

It is further explained that the detection mechanism 300 may be a displacement sensor or an inclination sensor to measure a linear displacement of the axis of the material shaft 200 in a direction perpendicular to the axis direction caused by bending.

In an optional embodiment, the AGV vehicle further comprises a control mechanism, the detection mechanism 300 is communicatively connected to the control mechanism, and the driving mechanism 4 is communicatively connected to the control mechanism.

It is further explained that the AGV vehicle further comprises a control mechanism; herein, the detection mechanism 300 is communicatively connected to the control mechanism, and the driving mechanism 4 is communicatively connected to the control mechanism. The detection mechanism 300 can transmit measured data obtained through detection to the control mechanism, and the control mechanism performs analysis based on the obtained measured data and controls the driving mechanism 4 to operate based on the analysis result, so as to compensate for the deflection of the material shaft 200. By providing the control mechanism, real-time automatic adjustment can be achieved.

Although some specific embodiments of the present application have been described in detail by way of examples, those skilled in the art should understand that the above examples are for illustration only and are not intended to limit the scope of the present application. Those skilled in the art should understand that modifications may be made to the above embodiments without departing from the scope and spirit of the present application. The scope of the present application is defined by the appended claims.

1. A deflection compensation device, comprising:
a mounting member, configured to mount a material shaft;
a fixing plate, wherein the mounting member is rotatably connected to the fixing plate about an axis of a Y direction;
a connecting member, rotatably connected to the mounting member about the axis of the Y direction; and
a driver provided on the fixing plate, having a driving end connected to the connecting member and configured for driving the connecting member to move along a Z direction, wherein the mounting member is configured for rotating about the axis of the Y direction.

2. The deflection compensation device according to claim 1, wherein the mounting member comprises a first mounting plate, a second mounting plate, and a third mounting plate, a first end of the first mounting plate is connected to the second mounting plate at an angle, a second end of the first mounting plate is connected to the third mounting plate at an angle, the first mounting plate is configured to mount the material shaft, the second mounting plate is rotatably connected to the fixing plate, and the third mounting plate is rotatably connected to the connecting member.

3. The deflection compensation device according to claim 2, wherein the connecting member comprises a first connecting plate and a second connecting plate, the first connecting plate is connected to the driving end of the driver, the first connecting plate is rotatably connected to a first end of the second connecting plate about the axis of the Y direction, and a second end of the second connecting plate is rotatably connected to the third mounting plate about the axis of the Y direction.

4. The deflection compensation device according to claim 3, wherein the third mounting plate comprises a groove along the Z direction, and the second end of the second connecting plate is embedded in the groove and rotatably connected to the third mounting plate.

5. The deflection compensation device according to claim 3, wherein the connecting member further comprises a first slider and a second slider, the first slider and the second slider are both disposed on an end of the first connecting plate adjacent to the fixing plate, and the first slider and the second slider are spaced apart along the Y direction; and
an end of the fixing plate facing the connecting member comprises a first guide rail and a second guide rail, the first guide rail and the second guide rail are spaced apart along the Y direction, the first slider is slidably connected to the first guide rail along the Z direction, and the second slider is slidably connected to the second guide rail along the Z direction.

6. The deflection compensation device according to claim 5, wherein the deflection compensation device further comprises a first limiting member, the first limiting member is provided on the fixing plate, and the first slider or the second slider is configured for abutting against the first limiting member; or
the deflection compensation device further comprises a first limiting member and a second limiting member, the first limiting member and the second limiting member are spaced apart on the fixing plate along the Z direction, and the first slider and the second slider are configured for moving between the first limiting member and the second limiting member.

7. The deflection compensation device according to claim 3, wherein the deflection compensation device further comprises a third limiting member, and the third limiting member is disposed on the fixing plate; and
the first connecting plate comprises a limiting rod, the limiting rod is configured for abutting against the third limiting member, and an axis of a connecting shaft between the first connecting plate and the second connecting plate is parallel to an axis of a connecting shaft between the second connecting plate and the third mounting plate on an X-Y plane.

8. The deflection compensation device according to claim 3, wherein the driver comprises a motor, a screw rod, and a nut seat, the motor is configured for driving the screw rod to rotate about an axis of the Z direction, the nut seat is rotatably connected to the screw rod, and the first connecting plate is connected to the nut seat.

9. The deflection compensation device according to claim 8, wherein an end of the first connecting plate facing the fixing plate comprises an accommodating groove, and the nut seat is embedded in the accommodating groove.

10. The deflection compensation device according to claim 8, wherein the driver further comprises a reducer, and the reducer is connected to an output end of the motor and the screw rod.

11. An AGV vehicle, comprising:
the deflection compensation device according to claim 1;
a material shaft, wherein one end of the material shaft is disposed on the deflection compensation device; and
a detector disposed on an end of the material shaft away from the deflection compensation device, configured to detect a deflection of the material shaft.

12. The AGV vehicle according to claim 11, further comprises a controller, the detector is communicatively connected to the controller, and the driver is communicatively connected to the controller.
